(19) United States
(12) Patent Application Publication
(10) Pub. No.: US 2026/0217547 A1
(43) Pub. Date: Jul. 30, 2026

(54) PROCESS FOR BORATE GRANULATION AND COMPOSITION

(71) Applicant: U.S. BORAX INC., Boron, CA (US)

(72) Inventors: Elizabeth Gingras-Lafleur, Canyon Country, CA (US); Daniel Suasnabar, Rancho Cucamonga, CA (US); Manikandadas Mathilakathu Madathil, Mesa, AZ (US); Nhi Ho, Palmdale, CA (US)

(73) Assignee: U.S. Borax Inc., Wilmington, DE (US)

(21) Appl. No.: 19/145,245

(22) PCT Filed: Dec. 27, 2023
(86) PCT No.: PCT/US2023/086008

§ 371 Date: Jul. 2, 2025

Related U.S. Application Data
(60) Provisional application No. 63/478,896, filed on Jan. 6, 2023.

(51) Int. Cl. C01B 35/12; C05D 9/00; C05G 5/12

(52) U.S. Cl. CPC C01B 35/12; C01P 2004/32; C01P 2004/61; C05D 9/00; C05G 5/12

(57) ABSTRACT

The present disclosure provides a process for forming borate granules and the resultant granular borate composition formed by the process. In an embodiment, the process includes dry blending (i) particles of a borate with (ii) particles of boric acid to form a dry particle blend and adding, onto the dry particle blend, water at a temperature from 55° C. to 105° C. The process includes forming wet granules comprising borate and boric acid and having a particle size from greater than 3 mesh to 14 mesh.

### BACKGROUND

Boron (B) is an essential micronutrient needed for normal plant growth and development. Boron is involved in many plant processes such as sugar transport, cell wall synthesis, lignification, meristematic tissue cell division, petal and leaf bud formation, cell wall structure integrity, sugar and hydrocarbon metabolism and their transport, ribose nucleic acid (RNA) metabolism, respiration, indole acetic acid (IAA) metabolism, cytokinin production and transfer, phenol metabolism, nitrogen fixation, pollen germination, pollen tube formation and seed formation.

The role of boron in plant growth was discovered in the 1920s and since then, boron deficiency is found in many crops. Boron deficiency shows in clearly defined ways in certain crops. Generally, by the time visible symptoms are seen, yields will already have been adversely affected. The best way to establish boron need is either through soil testing or through tissue analysis. In this way, boron supplementation can form part of a ‘balanced nutrition’ approach to crop fertilization.

Accurate application and distribution of boron to plants depends on consistent and even sizing of the boron particle, placing the morphology of the boron particle under ever-increasing scrutiny. Forces imparted upon the boron particle during bagging, transport, and application can fracture, crush and/or break the particle, adversely affecting particle (i) blend-ability, size, durability, and resulting in fines generation. Thus, the art recognizes the need for improved morphology in boron particles, and, in particular, boron particles with increased size, low fines generation, and improved sphericity and hardness.

### SUMMARY

The present disclosure provides a process. In an embodiment, the process includes dry blending (i) particles of a borate with (ii) particles of boric acid to form a dry particle blend and adding, onto the dry particle blend, water at a temperature from 55° C. to 105° C. The process includes forming wet granules comprising borate and boric acid and having a particle size from greater than 3 mesh to 14 mesh.

The present disclosure provides a composition. In an embodiment, a granular borate composition is provided and has a property selected from the group consisting of (i) a particle size from 3 mesh to 14 mesh, (ii) less than 2.0 wt % residual water, (iii) a boron content from 5 wt % to 20 wt %, (iv) a sphericity from 0.90 to 0.99, (v) a hardness from 5 lbs to 20 lbs, (vi) a fines content less than 0.5%, (vii) a degradation less than 1%, and (viii) combinations thereof.

### BRIEF DESCRIPTION OF THE DRAWING

FIG. 1 is a schematic representation of a granulation process and system in accordance with an embodiment of the present disclosure.

### DEFINITIONS

In order for the present disclosure to be more readily understood, certain terms are first defined below. Additional definitions for the following terms and other terms are set forth throughout the specification.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., from 1 or 2, or 3 to 5, or 6, or 7), any subrange between any two explicit values used herein is included (e.g., the range 1-7 above includes the subranges from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

“Blend” refers to an intimate physical mixture (that is, without reaction) of two or more materials or compositions. A blend may or may not be miscible (not phase separated at molecular level). A blend may or may not be phase separated.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or” unless stated otherwise, refers to the listed members individually as well as in any combination. Use of the singular includes use of the plural and vice versa.

### Test Methods

Degradation test. An 18 ounce sample of material to be tested is screened through a set of No. 6 and No. 8 size sieves (US standard 6 mesh and 8 mesh) for 1 minute using a Rotap screen apparatus. 100 g of the screened sample (−6 mesh+8 mesh) is transferred into an abrasion jar. 25 one half-inch stainless steel balls are added to the abrasion jar. The locking cover on the abrasion jar is placed and tighten the locking knob. The abrasion jar is placed on a roller set and run for 5 minutes. The sample is screened with 16 size sieve (16 mesh) for 2 minutes in a Rotap screen apparatus. The result is reported in percent degradation using the following equation:

$$\% Degradation = + 16 Mesh weight / initial jar sample weight * 100.$$

Fines. A “fine” is a material composed of particles in a size range less than 1 mm as defined in ASTM D1739. Fines are measured in accordance with ASTM D1739 Standard Test Method for Collection and Measurement of Dustfall (Settleable Particulate Matter). Weigh and record the weight of a bronze collection pan. Place an 18-mesh screen on top of the bronze collection pan and tare the scale. Add 100 grams of material to be tested to the 18 mesh screen and record the weight. Transfer the entire apparatus (the collection pan, 18-mesh screen with material plus the bronze lid) to a Combs gyratory sifting machine. Properly seat the apparatus and set the timer for 5 minutes. The timer will automatically turn off the gyratory machine after the 5-minute duration. Remove the apparatus from the gyratory sifting machine and weigh and record the weight of the bronze collection pan. Result is reported as percent fines (% fines) and is calculated using the equation below.

$$\% Fines = \frac{\begin{matrix}( Finalweight of collection pan + dust ) - \\ Inital weight of collection pan\end{matrix}}{Amount of materialaddedtoscreen} \times 100$$

Hardness. Hardness is the fracture strength of granules. The hardness of the granules is determined by screening a sufficient quantity of a granular material to obtain at least 10 granules in the −6+7 mesh (US standard mesh) fraction. The granules are placed on a flat metal plate on the postal scale and one granule at a time placed in the middle of the plate is being tested using a manually engaged drill press. The drill press evenly applies a stress on the surface of the granule, until the granule fractures. The force applied to fracture the granule is recorded on the scale. Each of the ten granules is tested in the same manner and the hardness is reported as an average of the ten, in pounds (lbs) per granule.

Mesh. Mesh (or U.S. standard mesh, or U.S. Mesh size) is defined as the number of openings in one square inch of a screen. For example, a 36 mesh screen will have 36 openings in one square inch of screen while a 150 mesh screen will have 150 openings in one square inch of screen.

Particle size. The particle size distribution of a material is determined by dry screening with a set of different sieves, ranging from 3 mesh to 14 mesh (US standard) opening, using a Rotap screen apparatus for about 2 minutes. The material retained on each screen is weighed and reported as a percent of the total sample weight. The test may be carried out three times and an average result reported for each screen size.

Sphericity. The sphericity of a granule or particle is determined by measuring the smallest diameter of the granule and measuring the largest diameter of the granule. Perfect sphericity has a value of 1.0. The smallest/largest diameters for at least 10 granules were measured and the average sphericity is reported. Sphericity is determined by the equation below:

$$Sphericity = granule smallest diameter / granule largest diameter .$$

### DETAILED DESCRIPTION

The present disclosure provides a process. In an embodiment, the process includes dry blending (i) particles of a borate with (ii) particles of boric acid to form a dry particle blend. The process includes adding water onto the dry particle blend, the water is at a temperature from 55° C. to 105° C. The process includes forming wet granules comprising the borate and the boric acid and having a particle size from greater than 3 mesh to 14 mesh.

Nonlimiting examples of suitable borate include trisodium orthoborate (Na₃BO₃), sodium metaborate (Na₃B₃O₆), sodium tetrahydroxyborate (NaB(OH)₄, as hydrate NaBO₂·2H₂O), borax (anhydrous Na₂B₄O₇), borax tetrahydrate (Na₂B₄O₅(OH)₄, as hydrate Na₂B₄O₇·4H₂O), borax pentahydrate (Na₂B₄O₅(OH)₄·3H₂O, as hydrate Na₂B₄O₇·5H₂O), borax decahydrate (Na₂B₄O₅(OH)₄·8H₂O, as hydrate Na₂B₄O₇·10H₂O), disodium octaborate (Na₂B₈O₁₃), disodium octaborate tetrahydrate (Na₂B₈O₁₃·4H₂O), disodium enneaborate (Na₂[B₈O₁₁(OH)₄]·[B(OH)₃]·2H₂O, as hydrate Na₄B₁₈O₂₉·11H₂O), sodium pentaborate (NaB₅O₈·H₂O), sodium pentaborate dihydrate (Na[B₅O₇(OH)₂]·H₂O, as hydrate NaB₅O₈·2H₂O), sodium pentaborate pentahydrate (NaB₅O₈·5H₂O), trisodium pentaborate (Na₃B₅O₈(OH)₂·H₂O, as hydrate Na₃B₅O₇·2H₂O), colemanite, calcium borate, sodium calcium borate minerals, ulexite, kernite, magnesium borate, potassium borate, zinc borate (hydrate or anhydrous), and combinations thereof.

In an embodiment, the borate is sodium tetraborate decahydrate or sodium tetraborate pentahydrate.

In an embodiment, the borate is sodium tetraborate pentahydrate, or Na₂B₄O₇·5H₂O.

“Boric acid,” as used herein, is a compound of boron, oxygen, and hydrogen with formula B(OH)₃ and having a Structure (A) below:

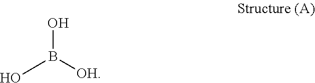

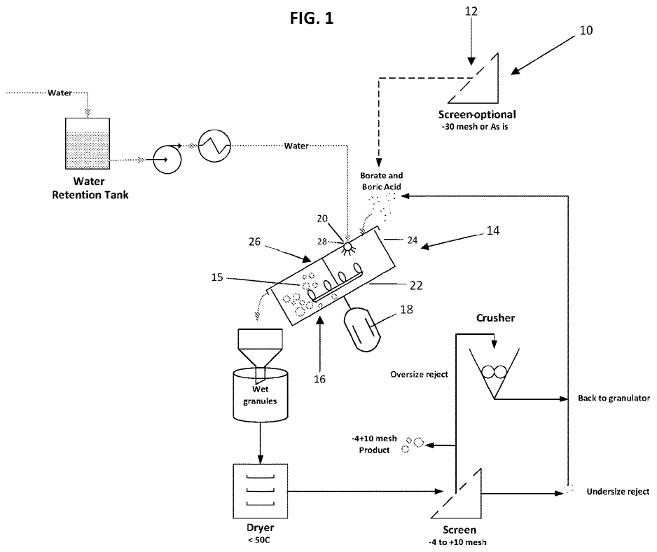

In an embodiment, the borate particles and/or the boric acid particles are pre-screened before the dry blending step. FIG. 1 is a schematic representation of the present process. A system 10 includes an optional pre-screening step 12 that can be performed on the borate particles and/or the boric acid particles. The borate particles may be pre-screened to the same size as the boric acid particles. Alternatively, the borate particles may be pre-screened to a particle size that is different than the pre-screen particle size for the boric acid particles. In a further embodiment, the borate particles and/or the boric acid particles are pre-screened to a particle size from 200 US standard mesh to 20 US standard mesh.

The process includes dry blending particles of the borate with particles of boric acid to form a dry particle blend. The dry blending may be performed in a granulator, a pin mixer, a disc pelletizer, a high intensity mixer, and combinations thereof. The dry particle blend contains boric acid particles and borate particles at a boric acid:borate weight ratio from 0.05: to 0.2:1, or from 0.05:1 to 0.15:1, or from 0.05:1 to 0.1:1 based on total weight of the dry particle blend. The dry blending forms a dry particle blend that is a homogeneous granular mixture of the borate particles and the boric acid particles.

In an embodiment, the borate particles and the boric acid particles are dry blended in a disc pelletizer 14 to form a dry particle blend 15. As shown in FIG. 1, the disc pelletizer 14 (also known as a pan pelletizer) includes a base (not shown) upon which a rotating disc 16 (or pan), a drive unit 18, and a spray system 20, are mounted, or otherwise supported. Rotating disc 16 has a bottom surface 22 and a circumferential wall 24 perpendicularly extending from bottom surface 22. Rotating disc 16 also includes an open top 26 opposing bottom surface 22. Drive unit 18 rotates rotating disc 16 in either a clockwise direction or a counterclockwise direction. The speed at which the rotating disc is rotated can vary.

Rotating disc 16 is inclined at an angle with respect to the horizontal plane as shown in FIG. 1. The angle of inclination can be varied and is typically between 30° to 60°. Disc pelletizer 14 includes a feed chute and a discharge chute (not shown). Disc pelletizer 14 may also include scrapers (not shown) that control the dry blend layer as it tumbles over the surface of the disc. Borate particles and boric acid particles are introduced through the feed chute and into rotating disc 16, the rotation of which forms dry particle blend 15.

The process includes adding heated water to the dry particle blend, the water heated to a temperature from 55° C. to 105° C., or from 70° C. to 105° C., or from 80° C. to 105° C., or from 90° C. to 105° C. or from 95° C. to 100° C. The addition of water can be by way of pouring, injecting, spraying, or combinations thereof. Mixing occurs as the heated water is added to the dry particle blend being rotated in the rotating disc 16.

In an embodiment, the process includes spraying heated water onto the dry particle blend as the dry particle blend is rotating in the rotating disc, the heated water having a temperature from 55° C. to 105° C., or from 70° C. to 105° C., or from 80° C. to 105° C., or from 90° C. to 105° C., or from 95° C. to 100° C. Spray system 20 includes spray nozzles 28, and a water source with suitable pumps/piping for delivery of heated water to rotating disc 16. One or more spray nozzles 28 spray heated water onto the rotating dry particle blend at a rate from 20 mL/minute (min) to 500 mL/min, or from 50 mL/minute to 200 mL/min, or from 50 mL/min to 150 mL/min, or from 50 mL/min to 100 mL/min.

The process includes forming wet granules composed of, or consisting of, borate and boric acid (and water), the wet granules having a particle size from greater than 3 mesh to 14 mesh, or from 4 mesh to 12 mesh, or from 4 mesh to 10 mesh.

The dry particle blend (the dry blend of borate particles and boric acid particles prior to water addition) defines a “total dry weight solids.” Spray system 20 is mounted over the top of rotating disc 16 and includes one or more spray nozzles 28. Spray nozzles 28 spray heated water (heated water having a temperature from 55° C. to 105° C., or from 70° C. to 105° C., or from 80° C. to 105° C., or from 90° C. to 105° C., or from 95° C. to 100° C.) onto the dry particle blend (i) at a rate from 50 mL/minute (min) to 200 mL/min, or from 50 mL/min to 150 mL/min, or from 50 mL/min to 100 mL/min and (ii) spray heated water at a water-to-total dry solids weight ratio from 0.05:1 to 0.3:1, or from 0.08:1 to 0.25:1, or from 0.1:1 to 0.25:1, or from 0.15:1 to 0.25:1 onto the blend and wetting the blend, and causing the blend to become tacky. The rotation of rotating disc 16 imparts a tumbling action upon the tacky material, thereby forming wet granules composed of the borate and the boric acid (and water). The water initiates binding between the borate and the boric acid. Rotation of rotating disc 16 continues after all the water is added for one minute to 60 minutes, curing the granules of borate and boric acid. The wet granules have a water content from 1 wt % to 10 wt % based on total weight of the wet granules.

In an embodiment, the process includes drying the wet granules to form dry granules having less than 2 wt % residual moisture. The wet granules are dried at a temperature range from 30° C. to 60° C., or from 40° C. to 50° C., or 50° C. using an oven dryer (or tray dryer), or a rotary dryer, a fluidized bed dryer, or any combination thereof, to remove residual moisture from the wet granules.

In embodiment, the wet granules are removed from disc pelletizer 14 through the discharge chute and transported to a tray dryer and dried at a temperature from 50° C. to 60° C. or from 50° C. to 55° C. for one minute to 120 minutes, or from one minute to 60 minutes to form dry granules having a particle size from greater than 3 mesh to 14 mesh, or from 4 mesh to 12 mesh, or from 4 mesh to 10 mesh, the dry particles consisting of only borate and boric acid (and optionally residual moisture/water), or 0 wt % residual moisture, or from greater than 0 wt % to less than 2 wt % residual moisture, or from 0.01 wt % to 1.5 wt % residual moisture, or from 0.05 wt % to 1.0 wt % residual moisture, residual moisture is based on the total weight of the dry granules.

In an embodiment, the process includes dry mixing particles of sodium tetraborate pentahydrate (borate particles) with particles of boric acid in a disc pelletizer at a boric acid-to-sodium tetraborate pentahydrate weight ratio from 0.05:1 to 0.20:1 to form a dry particle blend. The process includes rotating the dry particle blend in the rotating disc and spraying water heated to a temperature from 90° C. to 100° C. onto the blend (i) at a rate from 50 mL/min to 150 mL/min and (ii) in an amount of a water-to-total dry solids weight ratio from 0.1:1 to 0.2:1. The process includes forming wet granules composed of, or consisting of, sodium tetraborate pentahydrate, boric acid, and water having a particle size from greater than 3 mesh to 14 mesh, or from 4 mesh to 10 mesh. The process includes tray drying the wet granules in a drying oven at a temperature from 40° C. to 60° C. and forming dry granules having a particle size from greater than 3 mesh to 14 mesh, or from 4 mesh to 10 mesh and composed of, or consisting of, sodium tetraborate, boric acid, and optional residual moisture, or 0 wt % residual moisture, or from greater than 0 wt % to less than 2 wt % residual moisture, or from 0.01 wt % to 1.5 wt % residual moisture, or from 0.05 wt % to 1.0 wt % residual moisture.

The present process produces a granular borate composition having one, some, or all of the following properties:
(i) a particle size from 3 mesh to 14 mesh, or from 4 mesh to 10 mesh; and/or
(ii) 0 wt %, or from greater than 0 wt % to less than 2.0 wt % residual water; and/or
(iii) a boron content from 5 wt % to 20 wt %, or from 10 wt % to 18 wt %, or from 12 wt % to 17 wt %; and/or
(iv) a sphericity from 0.90 to 0.99, or from 0.92 to 0.98; and/or
(v) a hardness from 5 lbs to 20 lbs, or from 7 lbs to 15 lbs; and/or
(vi) a fines content of 0%, or from greater than 0% to less than 0.5%, or from 0.01% to 0.4%; and/or
(vii) a degradation less than 1%, or 0%, or from 0.01% to less than 1.0%, or from 0.05% to 0.9%.

Applicant unexpectedly discovered a cost-effective process for the production of borate granule with improved physical properties, the process requiring no binder (other than boric acid and water). The use of only boric acid and borate (and water) yields a granule with a higher concentration of boron, which is advantageous for use as a plant micronutrient.

By way of example, and not limitation, some embodiments of the present disclosure will now be described in detail in the following examples.

### Examples

Materials used in the inventive examples and comparative samples are provided in Table 1 below.

TABLE 1
Materials

| Product | Composition | Source |
|---|---|---|
| BA | Boric acid | Optibor ®, US Borax Inc. |
| | H₃BO₃, theoretical 56.3% B₂O₃ | |
| | Particle size ranging from −20 to 200 mesh (US standard) | |
| StB | Sodium tetraborate pentahydrate | Neobor ®, US Borax Inc. |
| | Na₂B₄O₇•5H₂O, theoretical 47.8% B₂O₃ | |
| | Particle size ranging from −20 to 200 mesh (US standard) | |

The rotating disc of an Eirich 10L high intensity mixer (model RV02E) is pre-heated to 38° C. prior to introduction of borate particles and boric acid particles. Particles of sodium tetraborate pentahydrate (“StB”) and particles of boric acid (“BA”) are dry blended in the rotating disc, the rotating disc rotating clockwise at 39 rpm for five minutes and the star rotor rotating counterclockwise at 10 to 20 meters per second (m/s) to form the dry particle blend. Heated water (temperature provided in Table 2) is then pumped by a peristaltic pump and sprayed through a spray nozzle located on a top lid of the rotating disc. The heated water is sprayed at varying rates and at varying volumes upon the dry particle blend to form the wet granules composed of sodium tetraborate pentahydrate and boric acid (and residual water). The amounts of sodium tetraborate pentahydrate particles, boric acid particles, and water are varied as shown in Table 2 below.

Disc rotation and rotor rotation is continued for 10 minutes after completion of the water addition, to allow for the binding reaction to occur and the wet granules to form and cure. Then the wet granules are transferred from the rotating disc onto a tray and the tray is transported to a Thermo Model Heratherm oven and dried at 50° C. for at least 60 minutes or until weight is stable, to form the dried granules having less than 2 wt % residual moisture.

The dry granules are screened to the desired particle size, using a Rotap screen apparatus for 2 minutes and different sieves ranging from 3 mesh to 14 mesh opening. The targeted particle size range was −4 to 10 mesh (US Standard). In this example, the process runs in batch mode, but in a continuous process, the undersized material would be recycled back to the feed of the granulator, and the oversized material would be crushed down to the feed particle size before being recycled back.

TABLE 2
Properties for comparative samples (CS) and inventive examples (IE)

| | CS1 | CS2 | CS3 | IE1 | IE2 |
|---|---|---|---|---|---|
| StB | 3000 g | 3000 g | 3000 g | 3000 g | 3000 g |
| Particle size | Pre-screened | Unscreened | Unscreened | Pre-screened | Unscreened |
| | −30 mesh | | | −30 mesh | |
| BA* | 150 g (5.0%) | 450 g (15.0%) | 210 g (7.0%) | 210 g (7.0%) | 300 g (10%) |
| Water^{&} | 240 g (8.0%) | 2070 g (61.0%) | 321 g (10%) | 321 g (10%) | 495 g (15%) |
| Water temp (° C.) | 100 | 100 | 23 | 100 | 100 |
| Water spray rate | 200 | No spray, water | 50 | 50 | 100 |
| mL/min | | poured onto blend | | | |
| Rotor speed | 10 | 20 | 10 | 10 | 10 |
| (m/s) | | | | | |
| Results | Low percentage | No wet granules | No wet granules | Excellent wet | Excellent wet |
| Granulation | of material | formed | formed | granulation | granulation |
| Behavior remarks | granulated | | | | |
| Sphericity | Good sphericity | No granule, not | No granule, not | Great sphericity | Great sphericity |
| | of the granules | measured | measured | obtained | obtained compared |
| | formed | | | compared to | to control. |
| | | | | control. | |
| Hardness | <5 lb/granule | No granule, not | No granule, not | >6 lb/granule | >7 lb/granule |
| | | measured | measured | | |
| Fines (dustiness) | Not measured | No granule, not | No granule, not | 0% | 0% |
| | | measured | measured | | |
| Degradation | >1% | No granule, not | No granule, not | <1% | <0.5% |
| | | measured | measured | | |

*Wt % ratio BA:StB
^{&}Wt % ratio water:total Wt -- StB + BA

For CS1, some wet granulation occurred but resulted in low yield of material granulated. Boric acid:sodium tetraborate weight ratio (0.05:1) and water to total weight solids weight ratio (0.08:1) were too low to wet and hind the dry blend properly, therefore only a small portion was able to granulate.

For CS2, wet granulation did not occur, the water:total solids weight ratio (0.61:1) was too large. The mixture formed a sticky paste and did not bind nor form granules upon drying.

For CS3, wet granulation did not occur. The mixture had the appearance of wet sand. Although it is believed the proportions of water and boric acid were large enough to wet and bind the material properly, the water temperature (23° C.) was too low to initiate the binding reaction.

For IE1, excellent wet granulation occurred. IE1 exhibited good recovery and produced discrete hard granules with uniform particle size.

For IE2, excellent wet granulation occurred. IE2 exhibited good recovery and produced discrete hard granules with uniform particle size. IE2 granules have 44.12 wt % B₂03 based on total weight of the granules.

Sphericity is determined from granules of IE2. Table 3 below provides sphericity from IE2 (inventive) and sphericity of a commercially available product that is sodium tetraborate pentahydrate compacted granules (comparative).

TABLE 3
sphericity

| | Sodium tetraborate pentahydrate | | | | | |
|---|---|---|---|---|---|---|
| | compacted granules | | | Wet Granulation (IE2) | | |
| | Diameter (mm) | | | Diameter (mm) | | |
| No. | Smallest | Greatest | Ratio | Smallest | Greatest | Ratio |
| 1 | 3.65 | 5.02 | 0.73 | 4.63 | 4.78 | 0.97 |
| 2 | 3.38 | 5.19 | 0.65 | 3.87 | 3.90 | 0.99 |
| 3 | 4.11 | 4.81 | 0.85 | 3.48 | 4.28 | 0.81 |
| 4 | 3.24 | 4.73 | 0.68 | 3.26 | 3.49 | 0.93 |
| 5 | 3.32 | 5.05 | 0.66 | 4.29 | 4.53 | 0.95 |
| 6 | 3.81 | 4.72 | 0.81 | 4.53 | 5.28 | 0.86 |
| 7 | 2.31 | 4.02 | 0.57 | 3.86 | 4.23 | 0.91 |
| 8 | 3.61 | 5.11 | 0.71 | 4.18 | 4.93 | 0.85 |
| 9 | 3.39 | 4.80 | 0.71 | 4.28 | 4.34 | 0.99 |
| 10 | 2.30 | 4.43 | 0.52 | 4.38 | 4.69 | 0.93 |
| 11 | 1.97 | 3.11 | 0.63 | 4.65 | 5.14 | 0.90 |
| 12 | 3.25 | 4.17 | 0.78 | 3.42 | 3.71 | 0.92 |
| 13 | | | | 3.73 | 4.02 | 0.93 |
| 14 | | | | 4.87 | 5.02 | 0.97 |
| Average | 3.20 | 4.60 | 0.69 | 4.10 | 4.45 | 0.92 |

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
dry blending (i) particles of a borate with (ii) particles of boric acid to form a dry particle blend;
adding, onto the dry particle blend, water at a temperature from 55° C. to 105° C.; and forming wet granules comprising borate and boric acid and having a particle size from greater than 3 mesh to 14 mesh.

2. The process of claim 1 comprising drying the granules to form dry granules having less than 2 wt % residual moisture.

3. The process of claim 1 comprising dry blending at a boric acid-to-borate weight ratio from 0.05:1 to 0.2:1.

4. The process of claim 3 wherein the dry particle blend defines a total dry solids weight, the process comprising spraying water at a water-to-total dry solids weight ratio from 0.05:1 to 0.3:1.

5. The process of claim 1 comprising spraying the water at a rate from 20 mL/min to 500 mL/min.

6. The process of claim 2 comprising forming dry granules comprising from 5 wt % to 20 wt % boron, based on the total weight of the dry granules.

7. The process of claim 2 comprising forming dry granules having a property selected from the group consisting of
(i) a sphericity from 0.90 to 0.99,
(ii) a hardness from 5 lbs to 20 lbs,
(iii) a fines content from 0% to 2%,
(iv) a degradation less than 1%, and
(v) combinations thereof.

8. A granular borate composition having a property selected from the group consisting of
(i) a particle size from 3 mesh to 14 mesh,
(ii) less than 2.0 wt % residual water,
(iii) a boron content from 5 wt % to 20 wt %,
(iv) a sphericity from 0.90 to 0.99,
(v) a hardness from 5 lbs to 20 lbs,
(vi) a fines content less than 0.5%,
(vii) a degradation less than 1%, and
(viii) combinations thereof.

9. The process of claim 7 comprising forming dry granules having a particle size from 4 mesh to 10 mesh.

10. The process of claim 7 comprising forming dry granules have a fines content of 0%.

11. The granular borate composition of claim 8 having a particle size from 4 mesh to 10 mesh.

12. The granular borate composition of claim 8 having a fines content of 0%.
